(19) United States
(12) Patent Application Publication
(10) Pub. No.: US 2003/0108350 A1
(43) Pub. Date: Jun. 12, 2003

(54) System and method for measuring the refraction

(76) Inventor: Johannes Brauning, Ostfildern (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/284,419

(22) Filed: Oct. 31, 2002

(30) Foreign Application Priority Data
Nov. 1, 2001 (DE) 101 53 397.7

(51) Int. Cl. G03B 1/00

(52) U.S. Cl. 396/661

(57) ABSTRACT

A system and a method for determining the refraction from a relative distance by using a camera (51), an illumination unit (52), a light blocking element unit and a control unit (52, 54, 55). A dynamic light intensity and/or illumination time adjustment is provided for the illumination unit and/or a detection of the patient distance and/or an automatic measuring range control are provided.

### BACKGROUND AND SUMMARY OF THE INVENTION

This application claims the priority of German Application No. 101 53 397.7 filed Nov. 1, 2001, the disclosure of which is expressly incorporated by reference herein.

The invention relates to a system and to a method for determining refraction and particularly a more precise measuring and an improved automation of a measuring operation which offering an incentive for coordinating the viewing direction.

Eccentric photo refraction is a method by means of which the refraction of an eye can be measured from a distance. This measuring method is therefore particularly suitable for uncooperative patients, such as small children. A conventional construction of a photo refraction system or video fraction system is known, for example, from German Patent Document 197 19 694 C2. The measuring system consists of a picture-recording system (such as a video camera) as well as of a special illumination system which is characterized essentially by a special arrangement of light-emitting diodes (infrared) arranged around an object. In correspondence with the light-emitting diode fields, a light blocking element is mounted on the objective which blocks off a portion of the emitted light reflected back by the eye. As a result, a light intensity profile is created in the pupil of the eye, which light intensity profile, after an analysis (for example, a regression), can be correlated with a reflection value. By means of the combination of several shutters and LED fields, the refraction of the eye can be determined in various axes, and the full refraction consisting of the sphere, the cylinder and the axis position can therefore be measured. In the above-mentioned German Patent Document DE 197 19 694 C2, a system is introduced which, consisting of a camera system, a shutter, an illumination system and a monitoring system, represents such a refraction unit. By means of this unit, the refraction can be measured in real time (video system).

One problem of the known methods is the varying reflectivity of the light source on the retina and, as a result, a varying course of the light intensity in the pupil. Furthermore, the light incident in the eye depends on the size of the pupil. The known methods provide no adaptation possibilities for this purpose. Likewise, the above-mentioned methods are susceptible to not maintaining the defined distance. Furthermore, the problem of offering a target for defining the viewing direction for a distance measuring process is not solved. In particular, it is not resolved to what extent a target can be offered for different “virtual distances”. Also, in this context, no methods are known for “fogging” an eye from the distance.

The present invention is concerned with providing a system and a method for determining the refraction by means of which the above-mentioned problem points of conventional systems can at least partially eliminated and which permit, in particulars a light intensity control for the adaptation to varying illumination requirements, a patient distance control and/or an automatic measuring range check as to whether the patient's or the test person's seeing characteristic is within the measuring range of the system.

The system according to the invention and the method according to the invention provide an automated adaptation of the measuring operation to the eye. The problem of the varying illumination requirement in the case of a pupil of a varying width as well as in the case of a varying reflectivity of the retina, which results in a non-uniform reflection of the pupil profile, is solved by a suitable controlling of the light intensity. The latter is based on the control of the illumination intensity as a function of the reflection of the retina under the above-mentioned varying conditions. For this purpose, a regulating circuit as well as a control are provided. Likewise, the problem of the display of a target (viewing target object) is solved. The target can “virtually” be adjusted to different “distances” of the eye. This makes it possible to influence the accommodation conditions corresponding to the target adjustments and thus to carry out accommodation measurements.

By means of regulating the light intensity of the illumination unit consisting, for example, of an LED arrangement, an adaptation to varying pupil sizes is permitted without reaching a range of an overcontrolling in the reflection of an eye. The regulating of the light intensity can take place automatically as a function of corresponding measured data.

According to another aspect of the invention, a distance check may be implemented by means of which the patient's distance to the measuring unit can be detected. On the one hand, this facilitates the precise positioning of a test person; on the other hand, measuring data of the refraction determination can be recorded at various measured patient distances and can be appropriately analyzed.

According to another aspect of the invention, a measuring range check is provided by means of which it is automatically detected whether a test person with his seeing characteristic is outside the unit measuring range of, for example, +5 diopters to −7 diopters. For implementing such a measuring range check, a system can be used which is based on the comparison of measurements which were implemented at a varying illumination. A positive result of the measuring range check will then be defined in that it is possible to control various illumination patterns, for example, by means of an LED arrangement.

### BRIEF DESCRIPTION OF THE DRAWINGS

Advantageous embodiments of the invention are indicated in the drawing and will be described in the following.

FIG. 1 is a schematic top view of a system for determining the refraction;

FIG. 2a is a schematic lateral view of a measuring head part with a camera of the system of FIG. 1;

FIG. 2b is a top view of a retinoscope system part with an illumination field arrangement and shutter arrangement for the system according to FIGS. 1 and 2a;

FIG. 3a is a schematic lateral view of a target system part for the system of FIG. 1 in a lens system embodiment;

FIG. 3b is a view corresponding to FIG. 3a but for a target system in a mirror system embodiment;

FIG. 4a is a schematic lateral view of a target system in a head-up display technique;

FIG. 4b is a schematic lateral view of another target system in a concentrating reflector technology;

FIG. 5 is a schematic representation of a regulating circuit for the dynamic illumination adjustment for the system of FIG. 1; and

FIG. 6 is a schematic top view of a system of the type of FIG. 1 accommodated in a compact housing.

### DETAILED DESCRIPTION OF THE PREFERRED EMBODIMENT

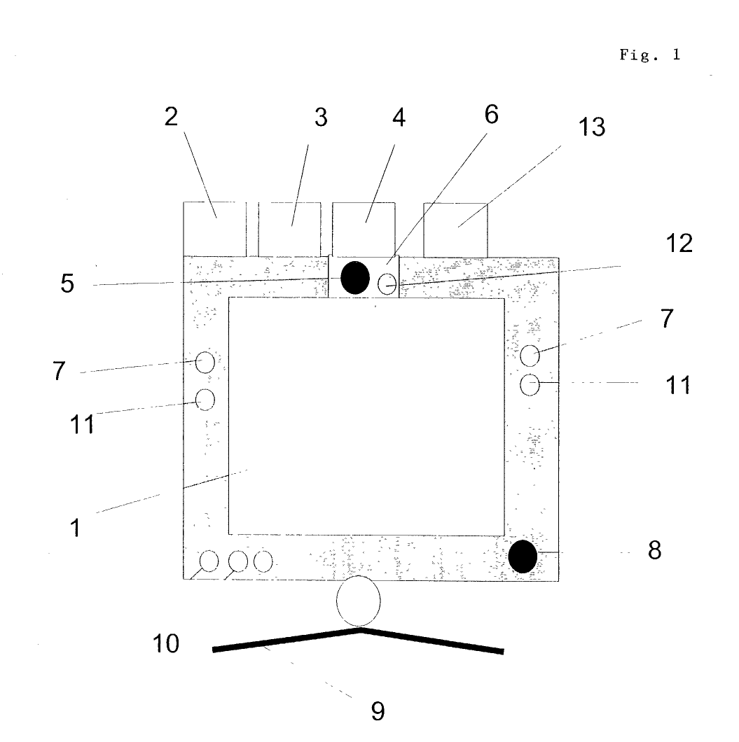

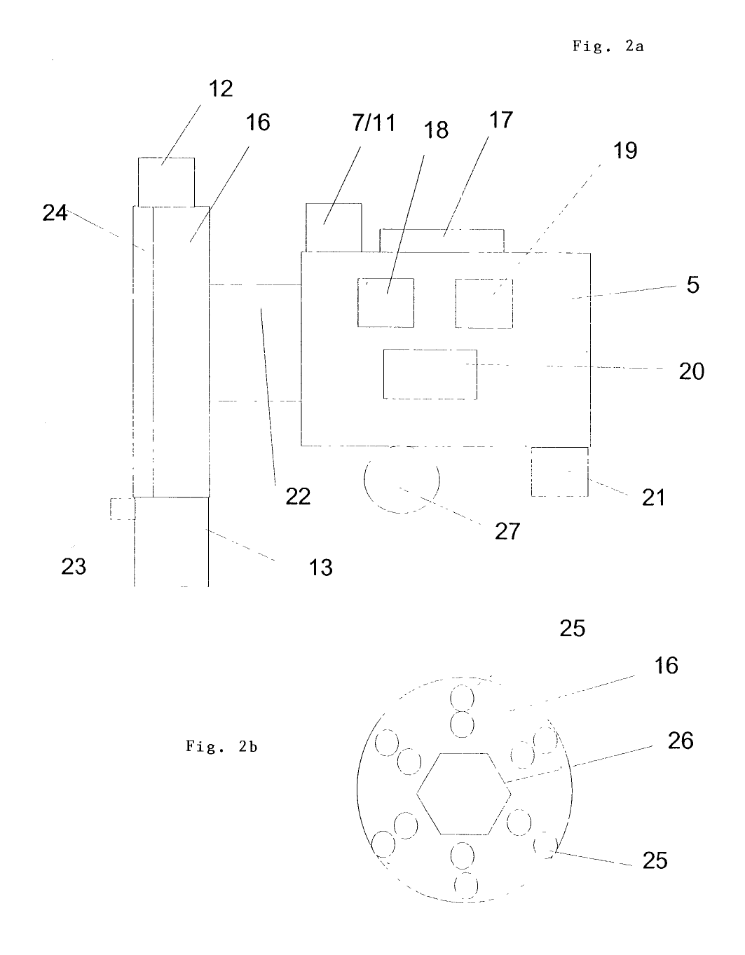

FIG. 1 is a schematic illustration of a refraction system of the above-described type. The system consists of a computer unit, for example, a PC, as well as a display screen 1. This unit is mounted on a pedestal 9 which is connected, for example, with a ball-and-socket joint for tilting and pivoting the unit. As illustrated in greater detail in FIG. 2a, the camera 5, which is required for the measuring and has an objective and an illumination unit and a shutter, is situated at the unit. The camera with the pertaining electronic system and illumination may be mounted in a digital construction as well as in a known analog construction. A digital construction could be implemented, for example, by way of an interface standard, such as IEEE 1394 or USB. An analog construction contains an analog-to-digital converter which makes the video data accessible to the PC (frame grabber). Likewise, in an analog application, a digital-to-analog converter is present which converts the control signals of the PC into analog signals in order to, for example, control the light intensity of LEDs.

A measuring unit for determining the distance between the unit and the patient is situated on the housing or on the camera 5. This measuring unit may be situated on the front side or on the back side of the unit. This is a function of the alignment of the camera (the camera may be aligned toward the front or the rear). The measuring of the distance may take place visually or acoustically. An acoustic measuring can preferably be implemented by means of an ultrasonic transmitter and an ultrasonic receiver 11. In this case, the receiver and the transmitter may be mounted on the PC housing as well as on the camera itself. A visual distance measuring device 7 may be implemented, for example, in the form of a visible or invisible (infrared) sensor or indicator. In the case of the sensor, a transmitting and receiving unit would automatically (by means of reflection) measure the distance with respect to the patient. In the case of a projection unit, for example, a pattern can be projected onto the test person (for example, the forehead) and this pattern, in the case of a visible light source, can be judged directly or, in the case of an invisible light source, can be further processed by the picture-taking camera and the software on the output side. By means of the two projection systems 7, the distance of a patient in front of the unit can be calculated as well as adjusted by means of triangulation.

The measuring data obtained by the distance measuring can be processed in two fashions. On the one hand, the data can be converted into an instruction for properly positioning the patient in front of the unit; on the other hand, the distance information can be actively included in the measuring program in order to adapt, for example, the refraction measurement to the obtained distance data. This system can be optimized in that the shutter of the camera can be included in the regulating circuit system. If a large shutter value is adjusted at the camera (small physical diameter), a high sharpness can be achieved by means of the camera system. The picture is therefore sharp over a fairly large distance range and can therefore be computed and further processed. The data obtained from the distance measuring systems concerning the patient's distance from the unit can be obtained in correlation with respect to the picture measuring data (sharp picture) over a greater distance range and can be calculated corresponding to the measured distance. Thus, from the combination of the camera, the relatively large shutter value and the distance measuring system, a type of “autofocus” is implemented for the refraction measuring by mean of eccentric photorefraction. Conversely, at a small shutter value (large physical shutter diameter), the distance measuring system can be utilized as an auxiliary instrument for the suitable positioning of the patent at a correct distance in front of the measuring system.

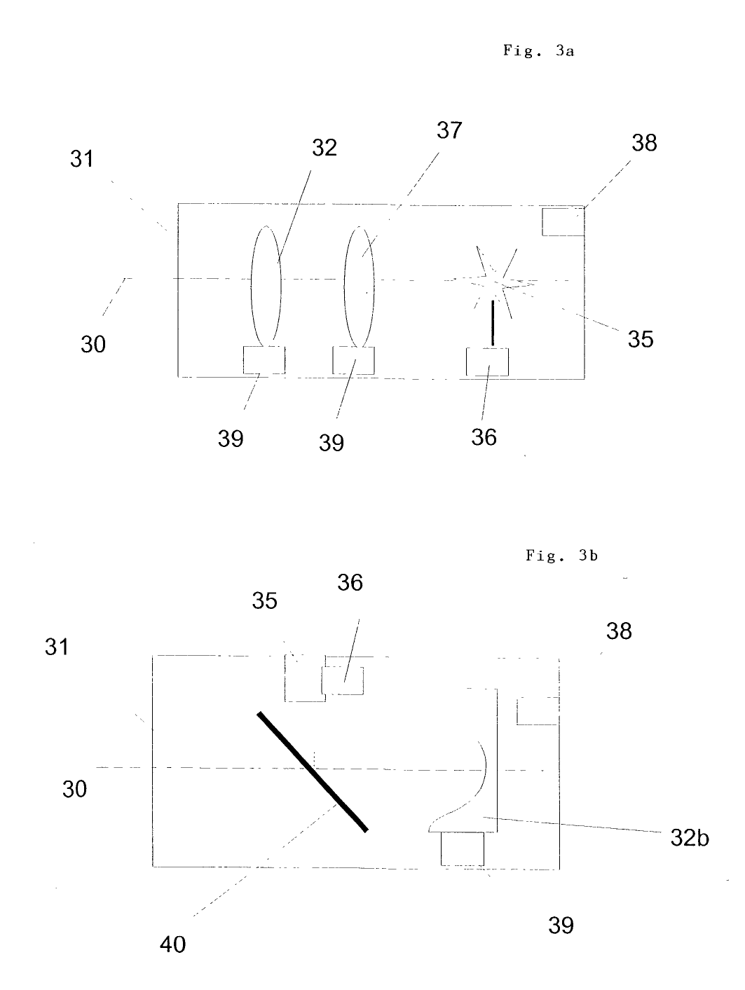

Furthermore, the camera can be moved or tilted and rotated in three axes at the measuring system. Likewise, the camera can be taken off and will then be connected with the system by means of a cable or a transmitting/receiving unit 2. In addition, the system can be equipped with a flash 4 for influencing the size of the pupils of the test person to be measured. The system can also be equipped with a room sensor 3 for measuring the light intensity of the room or for detecting unwanted infrared radiation emitters. Furthermore, the system may be equipped with a visible or invisible target beam 12 and the pertaining illumination and lens system for adjusting the patient in front of the system. In addition, the system contains a target 13 which will be described in greater detail in conjunction with FIG. 3. It is also conceivable to mount a mirror in front of the camera which shows the patient's own mirror image to the patient. The mirror should be reflective for visible light and penetrable for infrared light. If the mirror is situated directly in front of the camera, twice the distance at the measuring unit with a corresponding influence on the accommodation is simulated to the test person when he looks at the mirror. Also, control buttons 10 for the operation are mounted on the unit. This may also be implemented in the form of a so-called touch screen.

FIG. 2a is a schematic overview of various functions and modules of the camera. The camera may be integrated in the overall system as well as represent a “mobile measuring head”. If separated from the overall system, the measuring head may be connected with the PC system by means of a radio or cable connection. It is also conceivable to integrate the functionality of the PC system in a corresponding simplified processor technology and to implement it into the camera. The measuring head is always constructed of the so-called retinoscope 16, the objective 22 and the camera 5 itself. Here, the object of the camera as well as the LEDs may be equipped with filters (for example, interference filters, pole filters, lambda/4 plates).

The retinoscope contains illumination fields 25 which, as a rule, are equipped with infrared LEDs. In the example of FIG. 2b, the retinoscope 16 has six fields 25 to which one edge or light blocking element 26 respectively is assigned. The unit consisting of the illumination field 25 and the light blocking element 26 is defined as the retinoscope 16. The entire system is defined as the measuring head.

The measuring head may be equipped with various features which were illustrated in FIG. 1. By way of a rotary joint 27, the measuring head may be connected with the PC unit from FIG. 1. The objective 22 contains a manually or automatically (software-controlled) adjustable shutter adjustment. The target system 13 is connected with the measuring head. As an alternative, the retinoscope 16 can be covered by a mirror which reflects visible light and transmits invisible light (infrared). For an improved finding of the patient by means of the camera, an optical seeker 21, a target beam with a corresponding lens system 12 and/or a display 17 can be used which displays the actual camera picture. Likewise, a distance measuring device 7 or 11, as described, is mounted on the camera head. In the case of a cableless version, a transmitter 18 can send picture signals as well as control signals to the PC. The measuring head is also equipped with a key 19 for operating the measuring head. A grip 20 is used for a better handling.

FIGS. 3a and 3b represent examples of units for implementing a target or for implementing a fogging lens system. The units are accommodated in a housing. FIG. 3a represents a lens system; FIG. 3b represents a mirror system.

In FIG. 3a, various objects for the implementation are mounted along an optical axis 30. A front window 31 permits a view into a refractive element (such as a lens) 32. A second refractive element 37 may be situated in the continuation of the optical axis. A view onto a fixation object 35 is permitted by means of the refractive elements. All units along the optical axis can be moved mechanically. The refractive elements can in each case be moved individually by, for example, a spindle mechanism 39. The object 35 can also be moved by means of a mechanism 36. The movement of the lens system or of the mechanism is necessary in order to offer the object virtually at various distances or to correspondingly influence the accommodation of the eye. By means of the movable components, a “fogging” can also be carried out. In order to largely eliminate chromatic aberrations, a monochromatic illumination source 38 can be used inside the housing. As an alternative, the object 35 itself may also be illuminated monochromatically. As an alternative to the movement of the refractive elements or of the object, it is possible to implement an object which, in its spatial dimension, consists of various illumination units. This can be implemented, for example, in an LED row or in LED rings which extend along the optical axis. A pseudo displacement would therefore be possible by switching on or illuminating the individual objects along the optical axis.

FIG. 3b represents an alternative solution possibility. Here, the refractive element does not consist of lenses but of a mirror 32b (concave mirror). In this case also, the mirror 32 can be displaced by means of a mechanism 39 along the optical axis 30. A beam splitter 40 is constructed such that looking into a fixation object 35 is permitted by way of the mirror 32b. This object 35 also can be moved by means of a mechanism 36. As in FIG. 3a, an LED row, etc. is conceivable instead of a mechanically movable object. As in FIG. 3a, monochromatic light conditions 38 also apply here. As an alternative to the movement of the mirror, an adaptive mirror is also conceivable which can be adjusted in its refractive power. Such mirrors are currently implemented in so-called adaptive optical systems.

As an alternative, a target made of an IR transparent material may also be inserted into the beam path. If the target is provided with a handle, it can be held freely. An automatic position determination can take place in that the target is provided with an IR-reflective or IR-absorbing material. When at least two such objects are applied, the position of the target in the room can automatically be determined by means of software-supported object detection and triangulation.

In general, the accommodation width can be determined in an autorefractor in that the eye is confronted by means of a lens system (also virtually) by an object from the closest proximity into the infinite and beyond (“fog”). In this case, the refractive condition is measured at short intervals. This leads to a refraction condition distribution which, according to the individual situation, leads into a plateau phase in the proximity and in the distance. The differences of the plateau phases (diopters) corresponds to the accommodation width which can automatically be measured by means of this method.

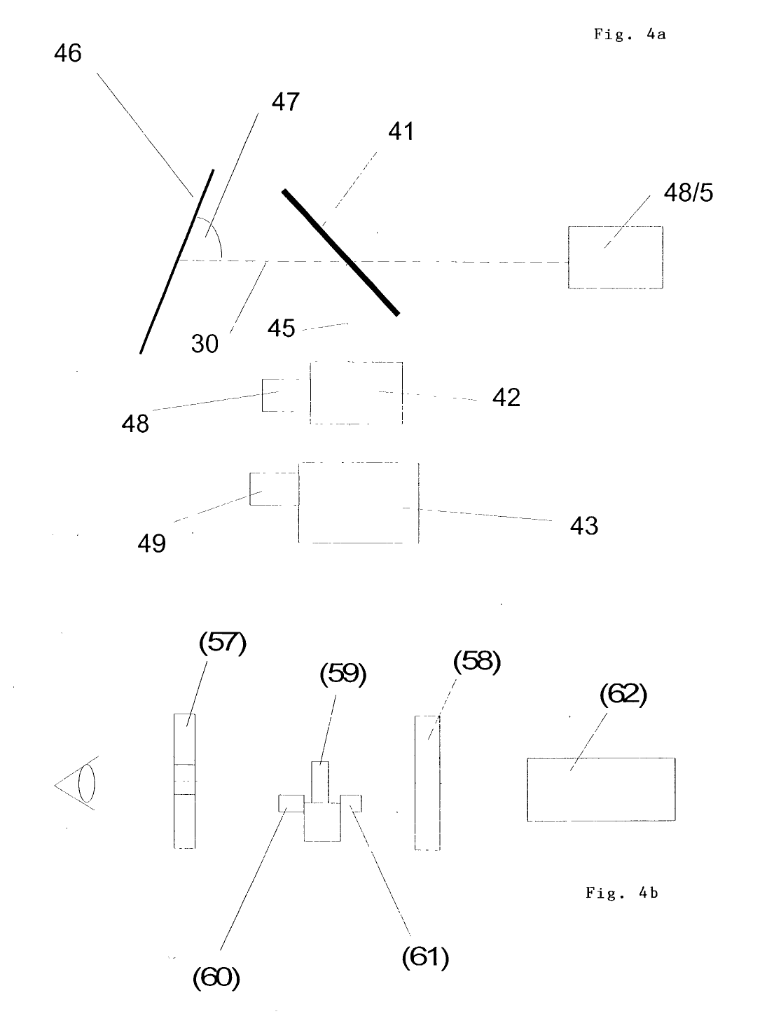

While FIGS. 3a and 3b introduced a looking-in target solution, FIG. 4a shows a target solution which offers a viewing target object by means of a head-up display technique. Although, in the case of the head-up display technique, a primitive target object can be used as the target, it is more intended for use of the display as the target unit. This method has the advantage that the real-time measurement, which is shown on the display, permits a direct looking-in by the patient and can simultaneously be used as a target for a generating at different virtual distances. FIG. 4a shows the basic construction of such a system. A corresponding mirror 41, which is transparent for infrared light, is inserted into the optical axis 45. A front window 46 situated in the optical axis is tilted at an angle 47 in relation to the optical axis of the camera with the retinoscope 48/5 in order to avoid reflections from the illumination coming from the measuring head. A refractive element 42 with a mechanical adjustment 48 along the mirror axis 45 is situated along the mirror axis 45. A target system 43 is inserted into the mirror axis 45, which target system 43 may be an object target system or a display 1. This system can also be moved along the optical axis 45 by means of a mechanism 49. In this arrangement, the mirror 41 is not transparent for visible light but is only transparent for IR light.

In a modification of FIG. 4a, it is conceivable to use a mirror 41 which is transparent for visible light. This may, for example, by a type of auto glass pane for head-up displays. If the elements are inserted along the axis 45 into the axis 44, the test person will look directly onto the projection unit or the refractive element 42 and/or the target system or the display 43. Here, the measuring head system 48 can be left in its eccentricity along the optical axis or, as an alternative, can be inserted into the optical axis 45. A metal oxide vaporized mirror would be used in this case. If all elements 42, 43, 48 are inserted along the optical axis 44, another target could additionally be inserted along the axis 45, for example, corresponding to FIG. 3a or 3b.

Another target solution is illustrated by FIG. 4b. An opening in a concave mirror 57 is used as the looking-in opening for the patient. A movable object 59 is imaged on the retina by an optical system 48, which consists, for example of displaceable concave mirrors. The object can optionally be illuminated from each side by the illumination unit 60, 61, so that two target positions can be visualized by means of one object position. As a result of the IR-transparent concave mirror, the refraction measuring takes place by means of the refractor 62.

Another target solution is represented by holograms on which the objects are recorded which represent virtual objects at different distances for the observer. Such objects may include optical systems, such as a telescope, in addition to everyday objects. As a result of the look through a holographically recorded optical system, for example, objects can then be implemented at any distance (for example, at close range and at infinity) as well as fogging.

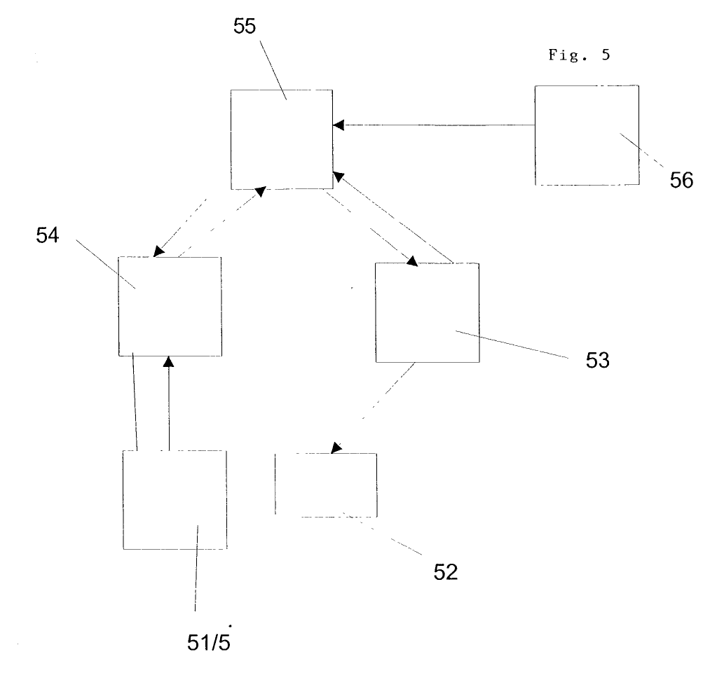

FIG. 5 represents a control circuit for the dynamic illumination adjustment. As a result of the dynamic illumination adjustment with the adjustability of the intensity and adjustability of the illumination duration of the retinoscope illumination, a manual adjustment of the shutter opening at the camera can largely be eliminated. The control circuit, which will be described in the following, is a function of the focussing of the overall system and is therefore only continuously active when the focussing of the overall system is ensured. This ensuring of the focussing can also be measured by means of the distance measuring system 56/11/7. The control circuit contains a standard adjustment for the LED intensity which defines the starting value or the restoring value. The camera 51/5 activates a picture which is transmitted to the image memory of the PC 54. An analysis of the picture with respect to the light intensity quality takes place by a CPU 55. Corresponding to the determined light intensity, a control signal is generated for the LED light intensity control 53. The control signal may determine a high-frequency or low-frequency pulse length as well as its periodicity or amplitude (current intensity). The control converts this signal to a signal for the illumination duration and/or the illumination intensity of the LED 52. The picture again taken by the camera 51/5 is again analyzed in the image memory 54, etc.

Likewise, it is possible to control the illumination time of the camera in the case of this control circuit. In order to prevent an “oscillating” of this control circuit, a signal from the distance measuring device is additionally integrated. If it can be derived from this signal that the object is within the focus of the camera, the LED light intensity is further adapted to a defined optimum. If it can be derived from the distance measuring signal that the object is situated outside the focus of the camera, the control circuit is interrupted and restored to a standard value. If a system is available which has no distance measuring signal, the control circuit will be activated and deactivated at certain intervals in order to prevent an oscillation. With respect to their intensity and control time, the LED fields can be controlled as an entire field but also individually according to various patterns.

This can take place as a function of the measured pupil size or of the reflection profile (for example, medium light intensity). In this case, the LEDs or the illumination can be operated at the same power or at a different power. In the case of a linear radial arrangement, for example, the intensity of the light would increase with an increasing eccentricity. Likewise, another LED field can be mounted outside the LED fields of the retinoscope at the housing or at the camera. This LED field is utilized for the comparative measurement of a reference LED field within the retinoscope in that the linearity of the reflection profile in the pupil is compared between an LED field “within” the retinoscope as well as an additional LED field “outside” the retinoscope. This comparison is used for determining (by means of the profiles) whether the test person is situated within the measuring range of the retinoscope, for example, in the range of from +5 diopters to −7 diopters. For this type of measuring range control, for example, a pattern of the light-emitting diode field with 5 light-emitting diodes of the interior two rows opposite four light-emitting diodes of the exterior two rows or in comparison to the entire light-emitting diode field can be used.

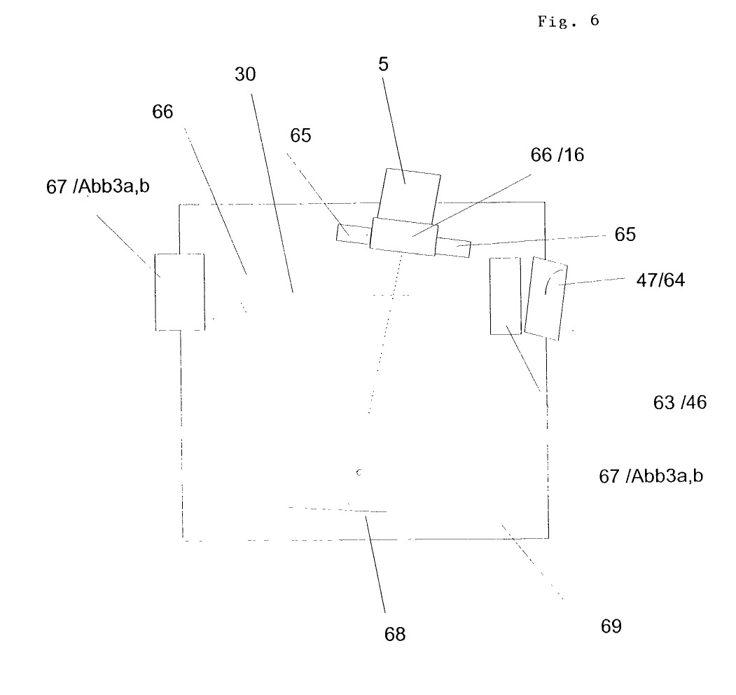

FIG. 6 shows the described device for the refraction measuring within a compact housing 69. In this case, the measured length was implemented, for example, by two mirrors 68/66 within the housing 69. The implementation of the measured length or the target length by more or fewer than two mirrors is also conceivable. The mirrors may have different reflective characteristics with respect to the wavelength of the light. The mirrors of the measured length at least reflect IR light. A looking-in window 45/64 consists of a plane face glass and is optionally not reflective for IR light or is tilted at an angle 47/64 with respect to the optical axis. Likewise, it is conceivable that optionally a refractive element can be mounted here.

The unit contains a target system 67 according to FIG. 3a or 3b for the “fogging” or for the provocation of the accommodation which can be imaged in or inserted. In the case of the imaging-in, the mirrors are not reflective for IR light. In the case of the presentation of the object in position 67, the mirror 66 is reflective for IR and is not reflective for visible light. The housing 69 can be illuminated on the interior side for influencing the pupil size. Likewise, it is conceivable to control the light intensity of the target for influencing the size of the pupil. Since the camera or the measuring head detects the pupil size and the system computes the pupil size in real time, it is possible to control the pupil size dynamically during the measuring operation by changing the illumination intensity.

Furthermore, the system is characterized in that measuring head with the camera 5 and the retinoscope 16 can be mechanically removed from the housing. As a result, measuring can take place by means of the measuring head alone also in the free space. Another variant consists of the fact that an additional illumination 65 of the retinoscope is situated in the housing 69. By inserting the measuring head in the housing 69, the illumination field of the retinoscope is thereby radially expanded which leads to an expansion of the measuring range. A corresponding sensor unit for the receiving of the measuring head reports this to the system.

Likewise, it is possible to image the measured length by means of a “telescope lens system” in the interior of a housing. By means of plus lenses, the opening angle of the objective of the camera can be condensed and can be opened again by means of a dispersing lens. Combinations of mirrors and a (telescope) lens system are also conceivable. Likewise, it is possible to switch off the illumination of the measuring head and mount or image in a corresponding illumination with a shutter in the area of the looking-in window 47.

11. System for determining the refraction from a relative distance, having a camera and illumination unit, a light blocking element unit and a control unit,
wherein the control unit comprises devices for the dynamic light intensity and/or illumination time adjustment for the illumination unit.

12. System for determining the refraction from a relative distance, particulary according to claim 11, having a camera, an illumination unit, a light blocking unit and a control unit, wherein a distance measuring unit is provided for determining the patient distance.

13. System for determining the refraction from a relative distance, particulary according to claim 11, having a camera, an illumination unit, a light blocking unit and a control unit, further including measuring range control devices which determine whether the seeing characteristic of a test person is within a definable refraction measuring range of the system.

14. System according to claim 11, wherein the illumination unit can be controlled for generating an illumination field with intensity differences in areas.

15. System according to one of claim 11, wherein the illumination unit contains an arrangement of several individual light sources which can be individually controlled for generating one or several definable illumination light intensity patterns.

16. System according to one of claim 11, further including devices for obtaining refraction measuring data as a function of distance date of the distance measuring unit.

17. System according to one of claim 11, further including an accommodation influencing lens system.

18. Method of determining the refraction from a relative distance by using a camera, an illumination unit, a light blocking unit and a control unit, at least one of the light intensity and the illumination time of the illumination unit is adjusted dynamically.

19. Method of determining the refraction from a relative distance by using a camera, an illumination unit, a light blocking unit and a control unit, wherein a patient distance is detected by a distance measuring unit.

20. Method of determining the refraction from a relative distance by using a camera, an illumination unit, a light blocking element unit and a control unit, wherein an automatic measuring range control is implemented during which it is determined whether a seeing characteristic of a test person is within a definable refraction measuring range.
